(19) United States
(12) Patent Application Publication
(10) Pub. No.: US 2024/0240733 A1
(43) Pub. Date: Jul. 18, 2024

(54) CABLE HANGER EXPANSION

(71) Applicant: Hubbell Incorporated, Shelton, CT (US)

(72) Inventor: Evan Ronald Martin, Litchfield, NH (US)

(21) Appl. No.: 18/413,841

(22) Filed: Jan. 16, 2024

Related U.S. Application Data
(60) Provisional application No. 63/439,386, filed on Jan. 17, 2023.

(51) Int. Cl. F16L 3/23; H02S 20/32

(52) U.S. Cl. CPC F16L 3/23; H02S 20/32

(57) ABSTRACT

A hanger for hanging electrical cabling, the hanger including a first end having a first connector for attaching to a first structure, a second end having a second connector for attaching to a second structure different from the first structure and a middle portion between the first end and the second end for hanging the electrical cabling.

### CROSS REFERENCE TO RELATED APPLICATIONS

The present disclosure is based on and claims benefit from co-pending U.S. Provisional Patent Application Ser. No. 63/439,386 filed, Jan. 17, 2023 entitled CABLE HANGER EXPANSION the contents of which are incorporated herein in their entirety by reference.

### TECHNICAL FIELD

The present disclosure relates generally to cable hangers and more specifically, to cable hanger expansion.

### DESCRIPTION OF THE RELATED ART

Structures are often provided for supporting different types of systems which may include electrical systems, electrical components, cabling or wiring, etc. Often, electrical cabling or wiring is run to and from various parts of these systems utilizing one or more types of cable management systems.

For example, the use of photovoltaic arrays to provide electrical power in commercial, residential, and other environments has become more and more popular. Photovoltaic arrays are generally composed of a number of photovoltaic or solar modules and may be set within a support structure such as a metallic frame or rail system that supports the photovoltaic modules.

The frame or rail system is attached to a structure such as a roof or the ground. When installing a photovoltaic array, a number of photovoltaic modules are assembled onto the frame or rail system. The metallic frames of the individual photovoltaic modules, and the structural pieces, e.g., the rails, on which the modules are mounted are generally made out of aluminum. Depending upon the size of the photovoltaic array, the rail system may include multiple metallic rails coupled or connected together in a grid-like pattern. To prevent shadowing on the solar panels, it is important that wires, electronic components, etc. remain away from the light receiving faces of the solar panels. This can be particularly difficult when solar panels which allow light to enter from the back and front (e.g., bi-facial installation) are utilized, since the cables and/or electrical components tend to hang or drape from the array, even when existing cable management systems are used. To ensure the integrity of cables running along the metal frames of the photovoltaic modules, the cables may be mounted to the metal frames using one or more of various types of wire management systems. The wire management systems provide neat, easy and efficient ways for connecting the cables to the support structure. Examples of cable management systems include various types of clips as well as various types of ties including twist ties, zip ties, hook and loop ties, crimped wire cable ties etc.

Maximizing energy production from photovoltaic arrays is important and is particularly important for utility-scale solar designers in order to provide a greater return on investment. One path to maximizing energy production involves the use of solar trackers which are used to expose the photovoltaic modules to more sun. Solar trackers, when connected to the solar modules or arrays move the arrays to track the movement of the sun in the sky. In this way, the solar modules are always positioned to take optimum advantage for harvesting the sun's energy. Such solar trackers are often provided in between interconnected rows of solar modules which are themselves interconnected with one or more cables. The solar trackers generally require their own unique frames or support structures separate from those used to support the solar modules. These unique frames and support structures should also be capable of holding the cables from the interconnected solar modules as well as the cables used to power and control the solar trackers themselves, in a neat, safe and efficient way. Because the solar trackers move the solar modules through various arcs and distances, the cables should be allowed some movement so as not to bind the system while still keeping the cables and wiring out of the way of moving parts to prevent pinching and out of the way of the solar modules to prevent shadowing.

Brackets or frames used to support solar tracking units and, in particular, utility scale solar tracking units, often utilize many different components including various types of brackets and are often provided in very specific configurations. While these brackets or frames may provide a firm secure support for the solar tracking unit, cables from the solar tracking unit and/or solar modules may be left hanging and subject to pinching and/or result in shadowing of the solar modules.

Existing cable management systems are generally not particularly well suited for use on all of the various types of brackets and frames utilized. For example, existing clips for attaching a cable to a bracket are not suitable for supporting the weight of the relatively large number of cables passing by the solar array and/or solar tracking unit and will tend to slip off the bracket because of their weight and the movement of the bracket as the solar tracking unit tracks the movement of the sun. The various types of ties currently being utilized provide limited support for the cable and tend to move and slide up and down the portion of the bracket to which they are attached as the bracket moves, which may end up causing the cables to be worn through exposing and/or damaging the inner wires.

A need exists for hangers for securely and reliably hanging and holding electrical cables to various types of structures.

### SUMMARY OF THE INVENTION

The present disclosure provides embodiments of electrical cable hangers for securing electrical components including cables to structures.

According to an exemplary embodiment a hanger for hanging electrical cabling includes a first end having a first connector for attaching to a first structure, a second end having a second connector for attaching to a second structure different from the first structure and a middle portion between the first end and the second end for hanging the electrical cabling.

According to another exemplary embodiment an electrical cable hanger for hanging electrical cable from a structure includes a segment of spring steel having a first end, a second end and an intermediate section between the first end and the second end. At least one of the first end and the second end includes a harpoon-style hook configured to be hooked to the structure and the intermediate section is configured for hanging the electrical cable.

### BRIEF DESCRIPTION OF THE DRAWINGS

The figures depict embodiments for purposes of illustration only. One skilled in the art will readily recognize from the following description that alternative embodiments of the structures illustrated herein may be employed without departing from the principles described herein, wherein:

FIG. 1 is a front perspective view of a photovoltaic array for describing illustrative embodiments of the present disclosure;

FIG. 2 is a rear perspective view of a photovoltaic array including a cable hanger according to an illustrative embodiment of the present disclosure;

FIGS. 3A and 3B are enlarged rear perspective view of the photovoltaic array including an electrical cable hanger according to an illustrative embodiment of the present disclosure;

FIG. 4 is a front view of an electrical cable hanger according to an illustrative embodiment of the present disclosure including magnified views of end portions thereof;

FIGS. 5A, 5B are perspective views of an end portion of the electrical cable hanger according to the present illustrative embodiment of the present disclosure;

FIGS. 6A, 6B are perspective views of an end portion of the electrical cable hanger according to the present illustrative embodiment of the present disclosure;

FIGS. 7A-7C are top views for describing how an end portion of the electrical cable hanger according to the present illustrative embodiment of the present disclosure is attached to a structure;

FIGS. 8A-8C are front views for describing how an end portion of the electrical cable hanger according to the present illustrative embodiment of the present disclosure is attached to a structure;

FIG. 9 is a front view of an electrical cable hanger according to another illustrative embodiment of the present disclosure including magnified views of end portions thereof;

FIG. 10 is an enlarged front view of an end portion of the electrical cable hanger according to an illustrative embodiment of the present disclosure;

FIG. 11 is an enlarged perspective view of an end portion of the electrical cable hanger according to an illustrative embodiment of the present disclosure;

FIGS. 12A-12C are top views for describing how an end portion of the electrical cable hanger according to the present illustrative embodiment of the present disclosure is attached to a structure;

FIGS. 13A-13C are front views for describing how an end portion of the electrical cable hanger according to the present illustrative embodiment of the present disclosure is attached to a structure; and

FIGS. 14A and 14B are front views of portions of electrical cable hangers according to additional illustrative embodiments of the present disclosure.

### DETAILED DESCRIPTION

The present disclosure provides embodiments of electrical cable hangers or supports for securing electrical wires and cables to a structure. By way of examples only, embodiments of the present disclosure will be described as being attached to support structures such as metal frames or rails upon which a solar array and/or solar tracking unit may be mounted. For ease of description, the support structures may be referred to interchangeably herein as frame, bracket or rail. The wires or cables referred to herein as being supported may be formed by one or more solid conductors and/or by one or more stranded conductors.

Electrical cable hangers according to exemplary embodiments of the present disclosure will be described as being formed from a material capable of assuming a particular shape and substantially retaining that shape. The material may be referred to herein as wire or rod. A non-limiting example of such material is spring steel. The spring steel may be in the form of a wire or rod having a substantially circular cross-section, although other cross-sectional shapes are contemplated. Alternatively, the spring steel may be in be in the form of a strip or sheet having a substantially rectangular cross-section. The wire or rod selected may alternatively include round galvanized steel, round stainless steel, flat rolled galvanized steel, flat rolled stainless steel, etc.

The spring steel may be coated with a suitable material to protect it from the environment. For example, the spring steel may be galvanized. Alternatively, other forms of environmentally protected materials such as stainless spring steel may be utilized. One or more portions of the material may be provided with a coating which is non-conductive and/or provides a higher coefficient of friction than the material itself. The gauge of the material is selected to be suitable for the size and/or number of cables to be held and generally may range between 6-18 gauge.

Although embodiments of the present disclosure will be described as being formed from a single segment of wire, it will be appreciated the single segment may actually consist of two or more individual segments joined by weld, solder, crimp, etc. to form the single segment. The terms cables and wires and variations thereof are used interchangeably herein.

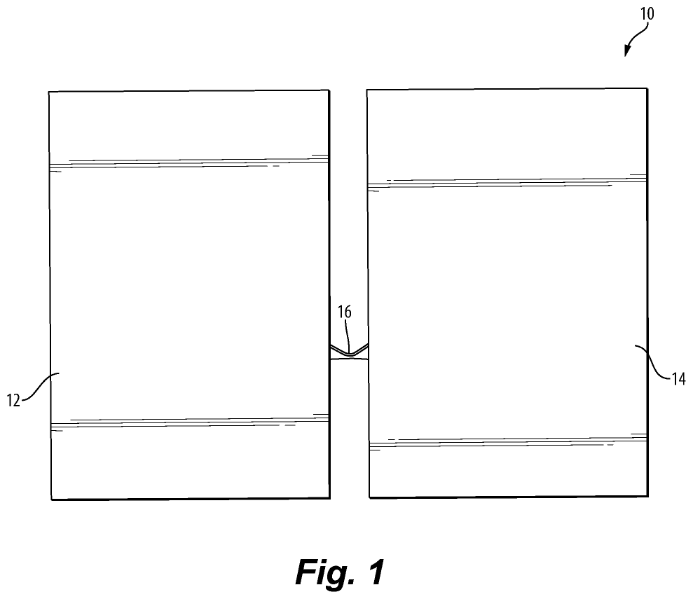

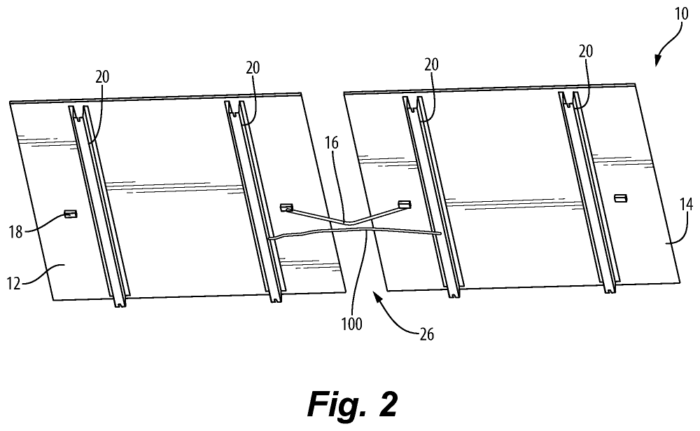

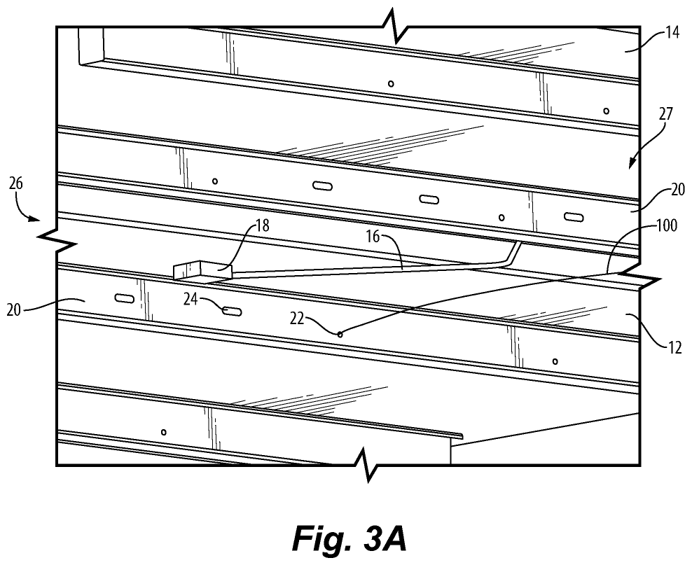

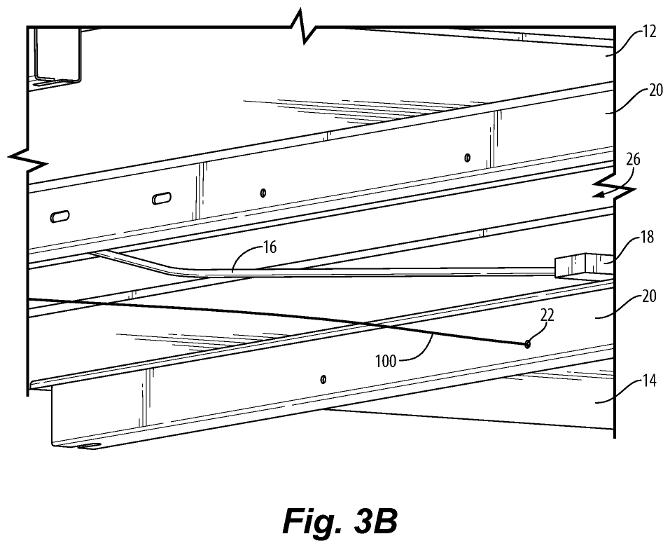

A portion of a photovoltaic array 10 is shown in FIGS. 1 and 2. Photovoltaic array 10 includes a plurality of photovoltaic modules 12, 14 each of which may have one or more connectors or junction boxes 18 for interconnecting the modules 12, 14 via cables 16. The back side of each photovoltaic module 12, 14 may include one or more rails 20 used to attach the photovoltaic module to one or more rails (not shown) forming a frame for the photovoltaic array 10. The rails 20 generally have a plurality of oblong holes 24 and/or round holes 22 in the sides thereof as shown in FIG. 3. Although not shown, the photovoltaic array 10 may be attached to any one of a variety of types of frame systems including, for example, fixed tilt, single axis tracker, dual axis tracker, etc. utilizing rails 20. The fixed tilt system, as the name implies is arranged so that the photovoltaic array 10 remains at a fixed angle. The single axis tracker and the dual axis tracker systems rotate the photovoltaic array along one or two axes, respectively, allowing the photovoltaic array to track the sun in the sky. Between the cabling required for the photovoltaic array and that required for controlling and powering the trackers, utility scale solar trackers utilize an enormous amount of cabling or wiring such that cable or wire management on such utility scale solar trackers can be a challenge. These utility scale solar trackers often have large bearing housing assemblies that require cables to be safely routed around them to prevent pinching and possible damage to the cables and to prevent shadowing on the photovoltaic modules.

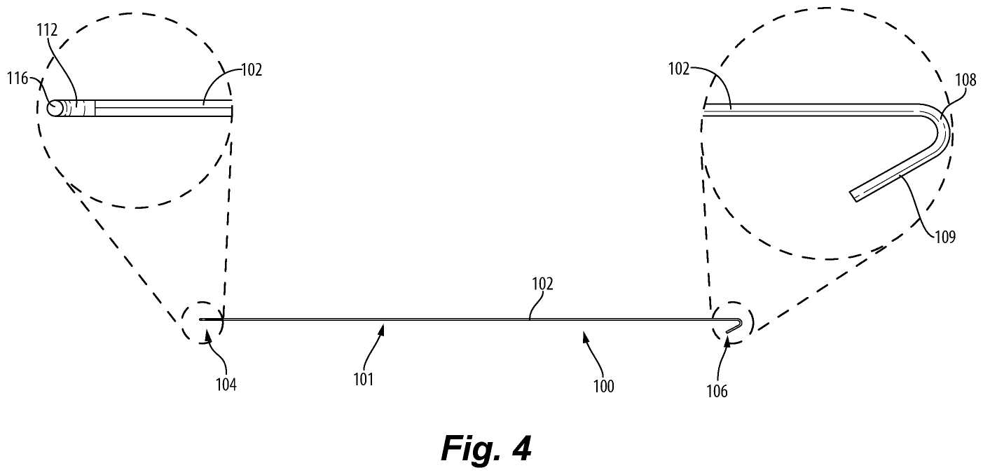

A spanning hanger 100 according to an illustrative embodiment of the present disclosure may be used to span the gap 26 between rails 20 on adjacent photovoltaic modules 12, 14 as depicted in FIG. 2-4. The spanning hanger 100 may also be used to span the gap 27 between rails 20 on the same photovoltaic module. As depicted in FIG. 3A, a first end of spanning hanger 100 is inserted and held within hole 22 in rail 20 of module 12. As depicted in FIG. 3B, the second end of spanning hanger 100 is inserted and held within hole 22 in rail 20 of module 14. Wires or cables may then be draped over the central or mid portion 102 (see FIG. 4) of spanning hanger 100 to provide a safe and efficient cable management system for managing cables routed within or past the photovoltaic array 10.

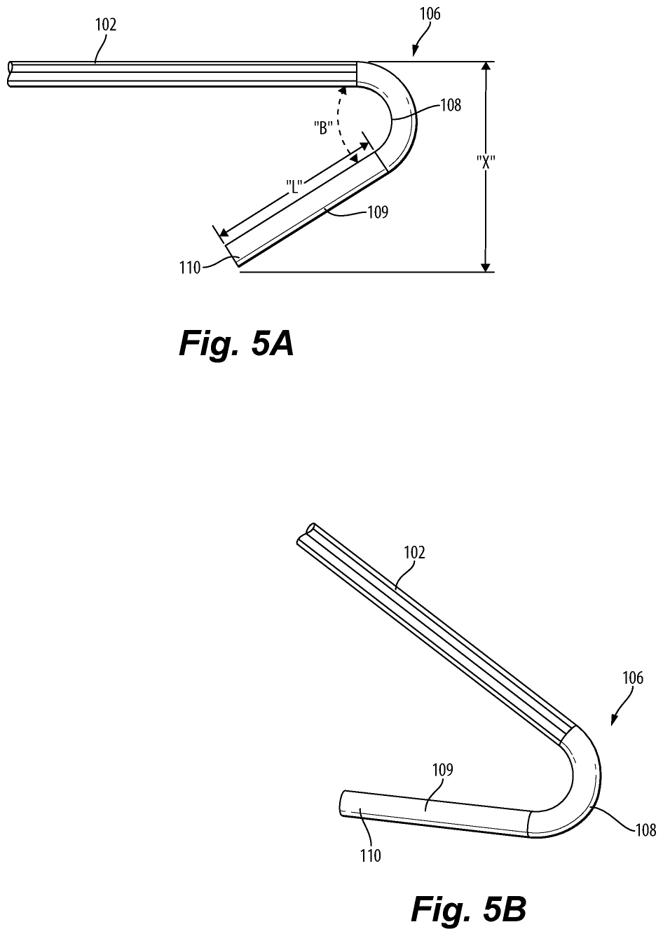

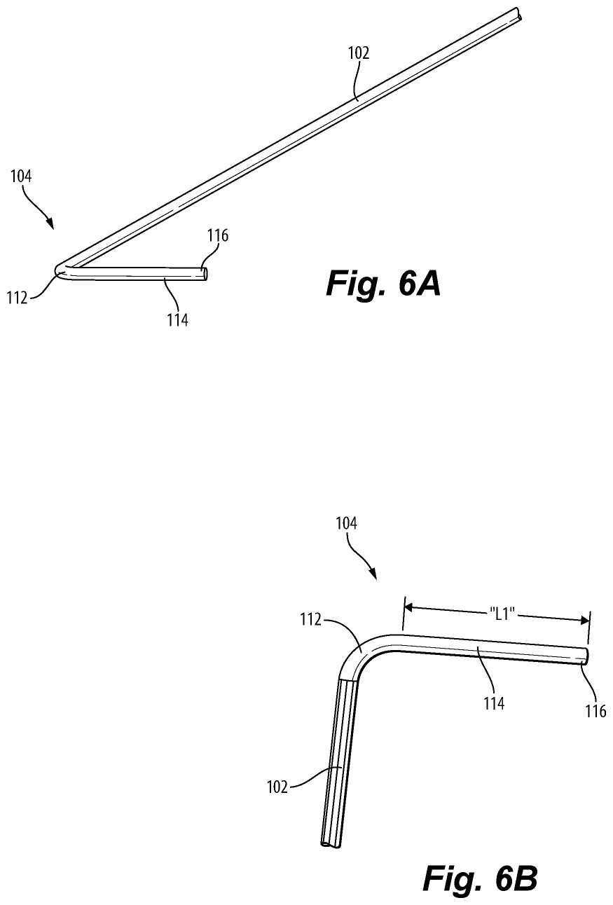

According to the present illustrative embodiment, central portion 102 of spanning hanger 100 is substantially straight as shown in FIG. 4. Spanning hanger 100 is formed from a rod of material such as, for example, stainless spring steel. The hook end or first end 106 and the second end 104 of hanger 100 according to an illustrative embodiment of the present disclosure are shown in the magnified views in FIG. 4 and in even further detail in FIGS. 5A, 5B and 6A, 6B, respectively. Assuming the portions of the hanger 100 forming central portion 102 and hook end section 106 are substantially in the same plane as the paper (e.g., the X-Y plane), end portion 114 (e.g., see FIG. 6A) extends substantially perpendicularly out of the paper in the Z-direction.

Depending on a particular application, end portion 114 may be in the same plane as hook end section 106 or may extend in another direction. Of course, the particular orientation may be reconfigured depending on a desired configuration. This may be accomplished during manufacture of hanger 100 or by the end user by manually manipulating the hanger 100 into the desired orientation.

The hook end or first end 106 is formed in the shape of a harpoon style hook which extends from the end of central portion 102 of hanger 100. Referring to FIGS. 5A, 5B, the distal end portion 109 of hanger 100 is bent at portion 108 such that the width “X” between the tip 110 of distal end portion 109 and the central portion 102 is greater than the diameter of the hole in which hook end 106 is intended to be seated. According to the present illustrative embodiment, the width “X” is greater than the diameter of holes 22 in rails 20. For example, according to a non-limiting example, the width “X” may be between approximately 0.2 inches and 0.5 inches.

It will be appreciated that the angle of the bend at portion 108 to achieve the desired width “X” may vary depending on factors such as the length “L” of distal end portion 109, the diameter of the wire forming hanger 100, the radius of the curve at bent portion 108, etc. According to a non-limiting example, the length of distal end portion 109 may be between approximately 0.2 inches and 0.5 inches and the angle B formed by bent portion 108 between central portion 102 and end portion 109 may be between approximately 20 degrees to 40 degrees.

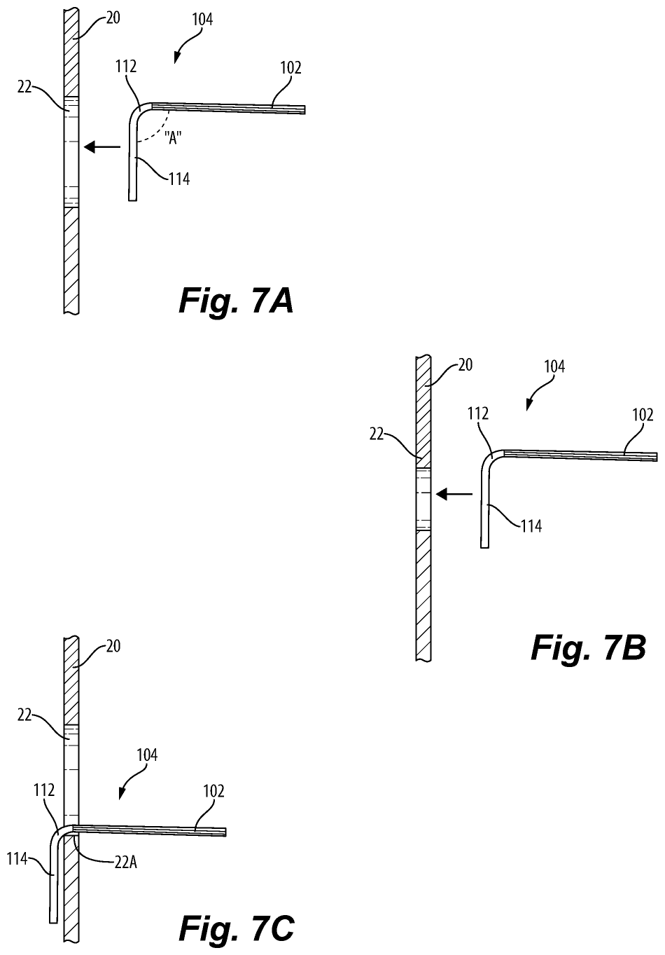

The second end 104 of hanger 100 according to an illustrative embodiment of the present disclosure is shown in FIGS. 6A and 6B. Second end 104 may also be in the shape of a harpoon style hook similar to first end 106. Alternatively, end 104 is formed in the shape of an “L” which extends from the end of the central portion 102 of hanger 100. While bent portion 112 of second end 104 is shown as having a substantially 90 degree bend, it will be appreciated from the present disclosure that bent portion 112 may be bent in any of various angles and the length “L1” of end portion 114 may be selected to be suitable for purposes as described in the present disclosure. In particular, the end 104 of hanger 100 is designed so that tip end 116 can be inserted in a hole 22 of rail 20 and the hanger 100 held in position by end portion 114. As shown in FIG. 7A, end portion 114 of hanger 100 may have a length “L1” which is substantially the same length or smaller than a diameter of hole 22. Alternatively, as shown in FIG. 7B, the length “L1” of end portion 114 of hanger 100 may be substantially longer than a diameter of hole 22.

For example, according to a non-limiting example, the length “L1” of end portion 114 of hanger 100 may be between approximately 0.25 inches and 1.00 inch. As shown in FIG. 7C, when the end portion 114 is inserted into hole 22, the bent portion 112 rests on the lower edge 22A of hole 22. End portion 114 abuts the inside surface of rail 20 effectively connecting hanger 100 to rail 20. To effectively hold hanger 100 and at the same time allowing the end portion 114 to be relatively easily positioned in hole 22, the angle “A” (see FIG. 7A) formed at bent portion 112 between end portion 114 and central portion 102 may be in the 45 degree to 135 degree range.

The length of central portion 102 may be substantially the same or longer than the distance between the rails 20 to which hanger 100 is to be attached. For example, according to a non-limiting example, the overall length of hanger 100 may be between approximately 10-40 inches.

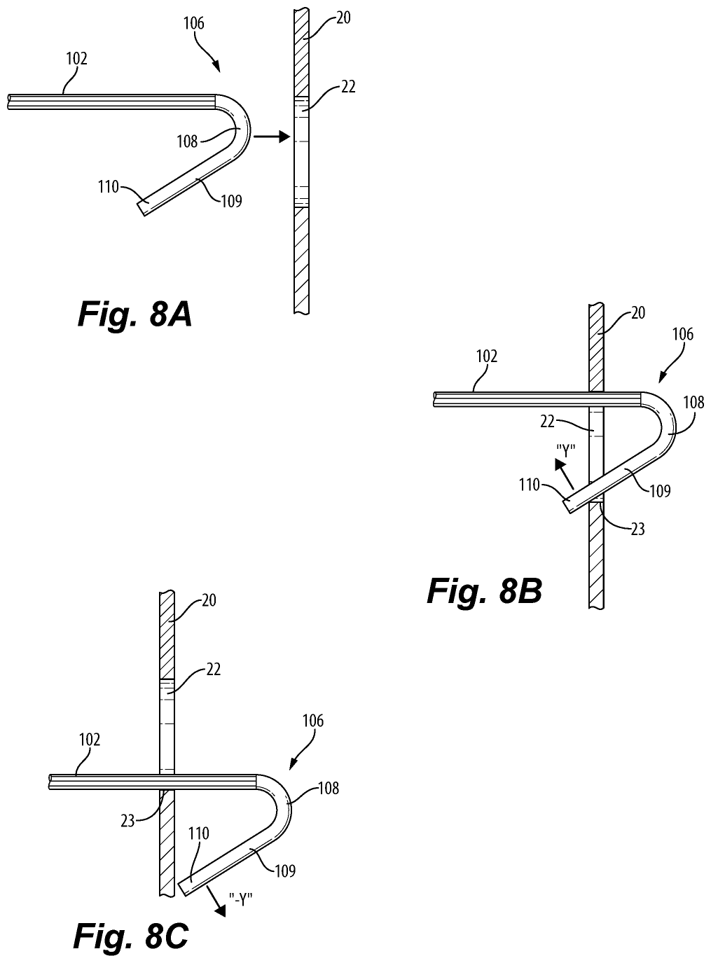

Since the hanger 100 is preferably made from spring steel, the central portion 102 of hanger may be manually bent when being attached to rails 20 and will spring back after being attached to rails 20. After end portion 104 is inserted into hole 22 of rail 20 mounted to photovoltaic module 12 as shown in FIG. 7C, the end portion 106 is inserted into a hole 22 of rail 20 mounted to photovoltaic module 14 as shown by the arrow in FIG. 8A. End portion 106 is pressed inward to hole 22, urging distal end portion 109 in the “Y” direction (FIG. 8B) until the tip 110 of distal end portion 109 is fully inserted and clipped into hole 22. Distal end portion 109 then expands in the “−Y” direction as shown in FIG. 8C effectively locking the hanger 100 between the rails 20 on modules 12 and 14.

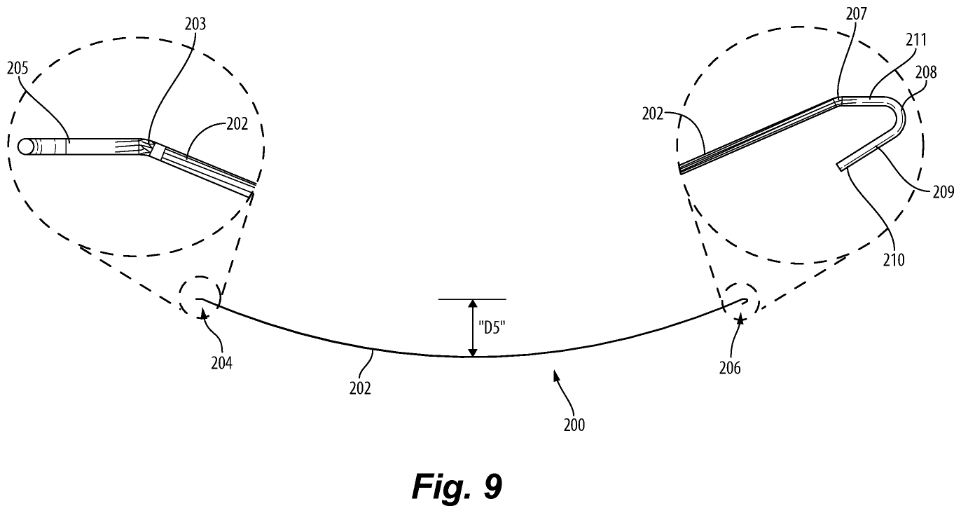

A spanning hanger according to another illustrative embodiment of the present disclosure is shown in FIG. 9 and is referred to herein as spanning hanger 200. Similar to the above-described embodiment, spanning hanger 200 may be used to span the gap 26 between rails 20 on adjacent photovoltaic modules 12, 14 depicted in FIG. 2-4. The spanning hanger 200 may also be used to span the gap 27 between rails 20 on the same photovoltaic module. For example, a first end 206 of spanning hanger 200 may be inserted and held within hole 22 in rail 20 of module 12. A second end 204 of spanning hanger 200 may be inserted and held within hole 22 in rail 20 of module 14. Wires or cables may then be draped over the central or mid portion 202 of spanning hanger 200 to provide a safe and efficient cable management system for managing cables routed within or past the photovoltaic array 10.

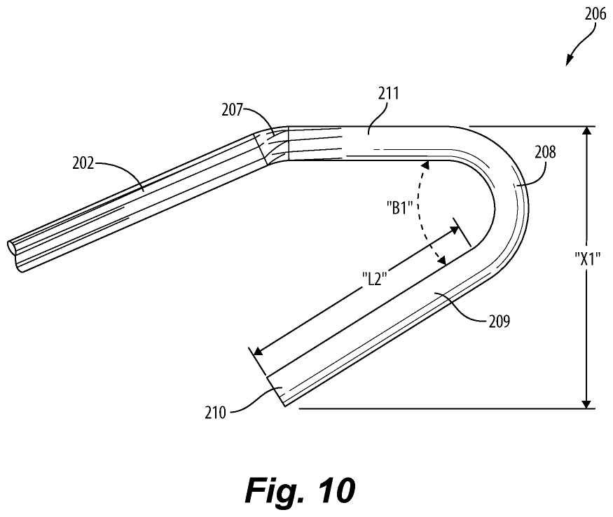

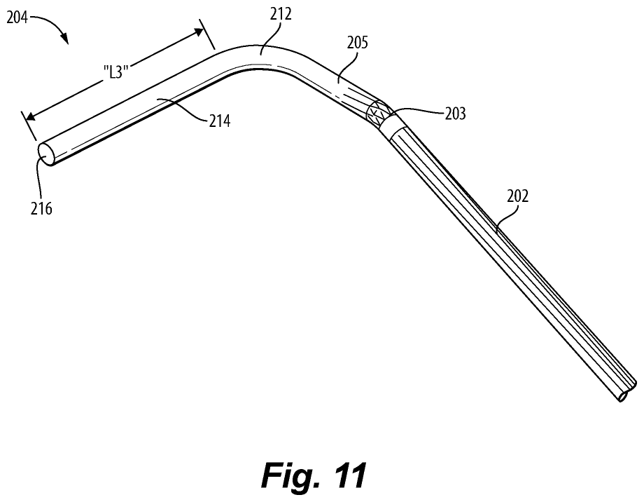

According to the present illustrative embodiment, central portion 202 of hanger 200 has a preformed arc as shown in FIG. 9. The hook end or first end 206 and the second end 204 of hanger 200 according to an illustrative embodiment of the present disclosure are shown in the magnified views in FIG. 9 and in even further detail in FIGS. 10 and 11, respectively. As shown in FIG. 9, assuming the portions of the hanger 200 forming central portion 202 and hook end section 206 are substantially in the same plane as the paper (e.g., the X-Y plane), the end portion 214 of second end 204 (see FIG. 11) extends substantially perpendicularly out of the paper in the Z-direction. According to a non-limiting example, the depth “D5” of the arc formed by central portion 202 (FIG. 9) may be between approximately 0.0 inches and 5.00 inches. Depending on a particular application, end portion 214 may be in the same plane as hook end section 206. Of course, this particular orientation may be reconfigured depending on a desired configuration of the spanning cable hanger 200. This may be accomplished during manufacture of hanger 200 or by the end user by manually manipulating the hanger 200 into the desired orientation.

Referring to FIGS. 9 and 10, central portion 202 is bent at the hook end or first end 206 at elbow 207 and at the second end 204 at elbow 203 such that end arm portions 211 and 205 are substantially parallel with each other and extend straight out in either direction from central portion 202 as shown. First end 206 is formed in the shape of a harpoon style hook which extends from elbow 207. The distal end portion 209 of hanger 200 is then bent at portion 208 such that the width “X1” (FIG. 10) between the tip 210 of distal end portion 209 and the end arm portion 211 is greater than the diameter of the hole in which first end 206 is intended to be seated. According to the present illustrative embodiment, the width “X1” is greater than the diameter of holes 22 in rails 20. For example, according to a non-limiting example, the width “X1” may be between approximately 0.2 inches and 0.5 inches. It will be appreciated that the angle of the bend at portion 208 to achieve the desired width “X1” may vary depending on factors such as the length “L2” of distal end portion 209, the diameter of the wire forming hanger 200, the radius of the curve at bent portion 208, etc. According to a non-limiting example, the length “L2” of distal end portion 209 may be between approximately 0.2 inches and 0.5 inches and the angle “B1” formed by bent portion 208 between end arm portion 211 and distal end portion 209 may be between approximately 20 degrees to 40 degrees.

The second end 204 of hanger 200 according to an illustrative embodiment of the present disclosure is shown in perspective view in FIG. 11. Second end 204 may also be in the shape of a harpoon style hook similar to first end 202. Alternatively, second end 204 is formed in the shape of an “L” which extends from the end arm portion 205 as depicted in FIG. 11. While bent portion 212 of end 204 is shown as having a substantially 90 degree bend, it will be appreciated from the present disclosure that bent portion 212 may be bent in any of various angles and the length “L3” of end portion 214 may be selected to be suitable for purposes as described in the present disclosure. In particular, the end 204 of hanger 200 is designed so that tip end 216 can be inserted in a hole 22 of rail 20 and such that end portion 214 maintains second end 204 in position within hole 22.

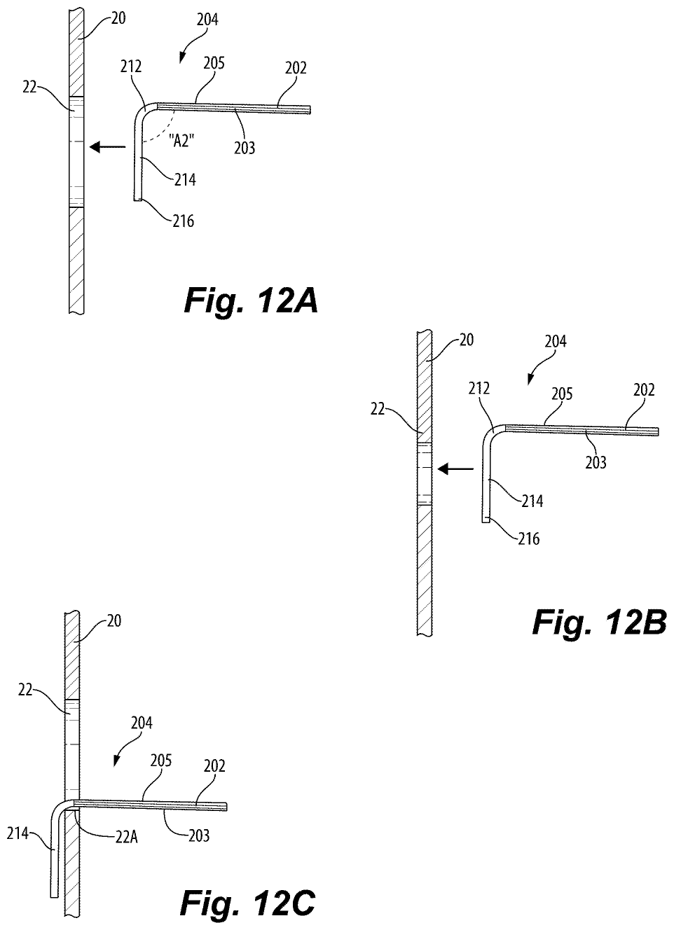

FIGS. 12A-12B are top views which depict end portion 214 being attached to rail 20 by inserting the tip 216 of end portion 214 in hole 22 formed in rail 20. As shown in FIG. 12A, end portion 214 of hanger 200 may have a length “L3” (FIG. 11) which is substantially the same length or smaller than a diameter of hole 22. Alternatively, as shown in FIG. 12B, the length “L3” of end portion 214 may be substantially longer than a diameter of hole 22. For example, according to a non-limiting example, the length “L3” of end portion 214 of hanger 200 may be between approximately 0.25 inches and 1.00 inch. As shown in FIG. 12C, when the tip end 216 of end portion 214 is inserted into hole 22, the bent portion 212 rests on the lower edge 22A of hole 22. End portion 214 abuts the inside surface of rail 20 effectively connecting hanger 200 to rail 20. To effectively hold hanger 200 and at the same time allowing the end portion 214 to be relatively easily positioned in hole 22, the angle “A2” (FIG. 12A) formed at bent portion 212 between end portion 214 and central portion 202 may be in the 45 degree to 135 degree range.

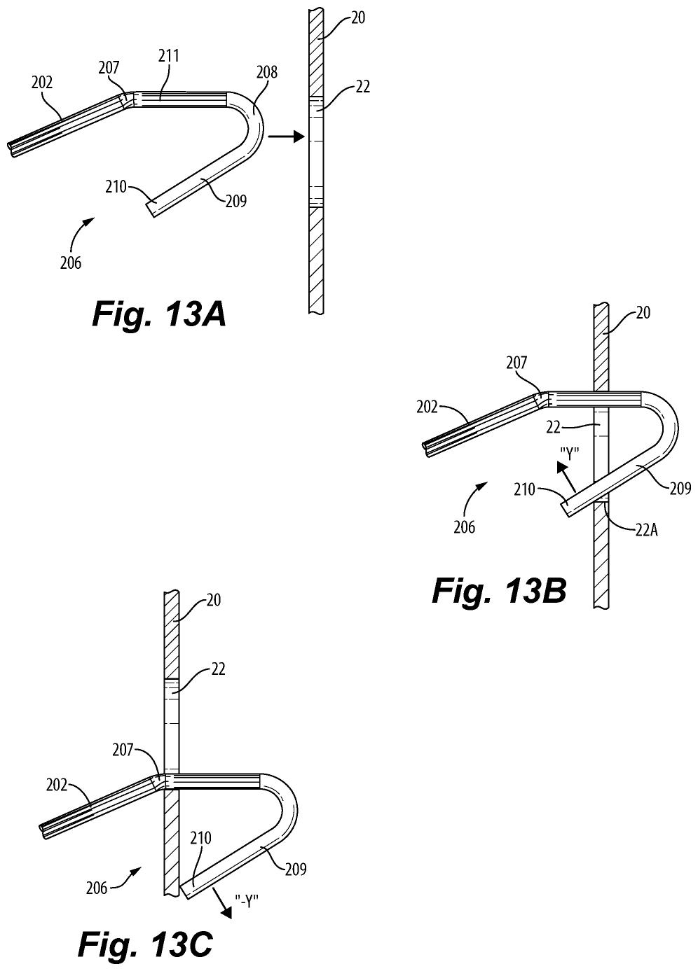

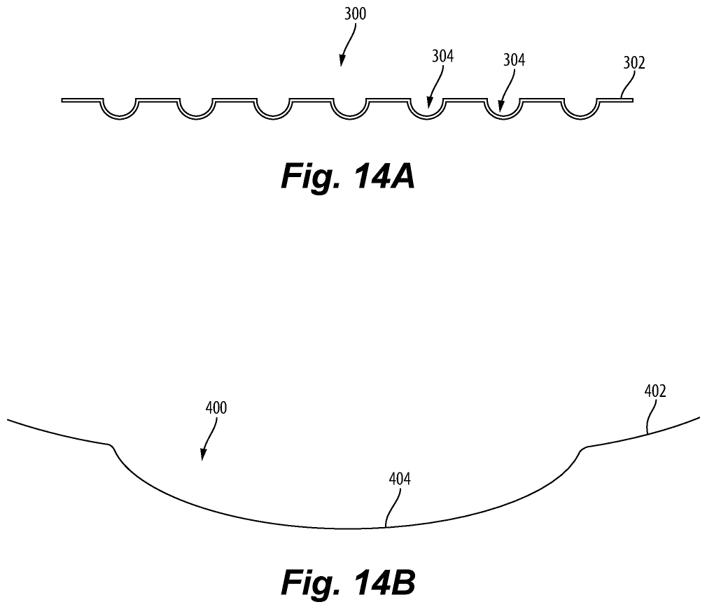

The length of central portion 202 may be substantially the same or longer than the distance between the rails 20 to which hanger 200 is to be attached. For example, according to a non-limiting example, the overall length of hanger 200 may be between approximately 20-40 inches. Since the hanger 200 is preferably made from spring steel, the central portion 202 of hanger may be manually bent even further than is already provided when being attached to rails 20 and will spring back after attached to rails 20. After end portion 214 is inserted into hole 22 of rail 20 mounted to photovoltaic module 12 as shown in FIG. 12C, the end portion 206 is inserted into a hole 22 of rail 20 mounted to photovoltaic module 14 as shown by the arrow in FIG. 13A. End portion 206 is pressed inward to hole 22, urging distal end portion 209 in the “Y” direction (FIG. 13B) until the tip 210 of distal end portion 209 is fully inserted through hole 22 and clipped in position. Distal end portion 209 then springs back in the “−Y” direction as shown in FIG. 13C effectively locking the hanger 200 between the rails on modules 12 and 14.

While the above-described embodiments depict the central or mid portions 102, 202 as being straight or having a preformed arc, it will be appreciated these portions of the spanning hangers may assume other shapes. For example, a central portion 302 of a spanning hanger 300 according to another illustrative embodiment of the present disclosure is shown in 14A. Central portion 302 is substantially straight and includes a series of half circular receptacles 304 each dimensioned to receive and hold a cable. For example, receptacles 304 may be provided having an inside diameter of ¾″ and may be suitable for receiving cables having outside diameters ¾″ or less. Receptacles 304 may be provided having an inside diameter of 1″ and may be suitable for receiving cables having outside diameters 1″ or less. The receptacles may include those dimensioned to receive cables of various sizes. For example, the receptacles 14 may be specifically dimensioned to receive cables of a first diameter and those specifically dimensioned to receive cables of second, third, etc. diameters. It will be appreciated that although central portion 302 is depicted as substantially straight similar to central portion 102 described above, the central portion 302 may have a preformed arc similar to that described above with respect to central portion 202. The end portions of spanning hanger 300 may include one or more of the end portions described above with respect to earlier described embodiments (e.g., harpoon style hook and/or L-shaped hook). Receptacles 304 maintain the cables separate from each other and provide even further protection for the cables being held by hanger 300. A central portion 402 of a spanning hanger 400 according to another illustrative embodiment of the present disclosure is shown in 14B. Central portion 402 has a preformed arc similar to central portion 202 described with respect to the above embodiments and includes one or more well-like portions 404 capable of receiving and holding a number of cables. The end portions of spanning hanger 400 may include one or more of the end portions described above with respect to earlier described embodiments (e.g., harpoon style hook and/or L-shaped hook). Well-like portion(s) 404 keep the cables together and provide further protection for the cables being held by the central portion 402 of the spanning hanger 400.

A coating may be provided on at least the portions of any of the above described hangers that come in contact with wires or cables. For example, as illustrated in FIG. 4, central portion 102 may include a coating 101. Depending on a particular application, coating 101 may be an electrical insulator and/or may provide a higher coefficient of friction than the material forming the hanger itself. This allows the electrical wires and cables being held in loop opening to be electrically isolated from the hanger 100 and any structure upon which the hanger 100 is mounted. Providing a material with a higher coefficient of friction provides a surer grip to hold the wires and cables in position. Examples of suitable coatings may include rubber or rubber like materials, plastics, varnish, etc. Coating 101 may be applied to hanger 100 in any suitable manner including, for example, by brush, spray or dipping, etc. Of course, any of the embodiments described herein may have the coating 101 applied to all of the hanger or only the portion of the hanger that will contact cables or wires being held by the hanger.

As shown throughout the drawings, like reference numerals designate like or corresponding parts. While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure.

Accordingly, the present disclosure is not to be considered as limited by the foregoing description.

What is claimed is:

1. A hanger for hanging electrical cabling, the hanger comprising:
a first end comprising a first connector for attaching to a first structure;
a second end comprising a second connector for attaching to a second structure different from the first structure; and
a middle portion between the first end and the second end for hanging the electrical cabling.

2. The hanger as recited in claim 1, wherein at least one of the first connector and the second connector comprise a harpoon style hook.

3. The hanger as recited in claim 1, wherein at least one of the first connector and the second connector comprise an L-shaped hook.

4. The hanger as recited in claim 1, wherein at least one of the first connector and the second connector comprise at least one of a harpoon style hook and an L-shaped hook.

5. The hanger as recited in claim 1, wherein the middle portion comprises a straight section.

6. The hanger as recited in claim 1, wherein the middle portion comprises an arc.

7. The hanger as recited in claim 1, wherein the middle portion comprises at least one portion dimensioned to receive at least one cable.

8. The hanger as recited in claim 7, wherein the at least one portion comprises a semi-circular shape dimensioned to receive one cable.

9. The hanger as recited in claim 7, wherein the at least one portion comprises a shape dimensioned to receive a plurality of cables.

10. The hanger as recited in claim 1, wherein the hanger comprises a rod.

11. The hanger as recited in claim 10, wherein the rod comprises stainless steel.

12. An electrical cable hanger for hanging electrical cable from a structure, the electrical cable hanger comprising:
a segment of spring steel comprising a first end, a second end and an intermediate section between the first end and the second end; and
wherein at least one of the first end and the second end comprise a harpoon-style hook configured to be hooked to the structure and the intermediate section is configured for hanging the electrical cable.

13. The electrical cable hanger as recited in claim 12, wherein at least one of the first end and the second end comprise an L-shaped hook.

14. The electrical cable hanger as recited in claim 12, wherein the intermediate section comprises a straight section.

15. The electrical cable hanger as recited in claim 12, wherein the intermediate section comprises an arc.

16. The electrical cable hanger as recited in claim 12, wherein the intermediate section comprises at least one portion dimensioned to receive at least one cable.

17. The electrical cable hanger as recited in claim 16, wherein the at least one portion comprises a semi-circular shape dimensioned to receive one cable.

18. The electrical cable hanger as recited in claim 16, wherein the at least one portion comprises a shape dimensioned to receive a plurality of cables.

19. The electrical cable hanger as recited in claim 12, wherein the spring steel comprises a rod.

20. The electrical cable hanger as recited in claim 19, wherein the spring steel comprises stainless steel.
